(19) United States
(12) Patent Application Publication
(10) Pub. No.: US 2011/0021587 A1
(43) Pub. Date: Jan. 27, 2011

(54) METHODS OF REDUCING OR ELIMINATING BACTERIA IN CONSUMABLE EGGS

(75) Inventors: George W. Cook, JR., Baton Rouge, LA (US); Christopher J. Nalepa, Zachary, LA (US); Joe D. Sauer, Baton Rouge, LA (US)

Correspondence Address: ALBEMARLE CORPORATION;PATENT DEPARTMENT, 451 FLORIDA STREET, BATON ROUGE, LA, 70801, US

(73) Assignee: Albemarle Corporation, Baton Rouge, LA (US)

(21) Appl. No.: 12/922,552

(22) PCT Filed: Mar. 25, 2009
(86) PCT No.: PCT/US09/38191

§ 371 Date: Sep. 14, 2010

Related U.S. Application Data
(60) Provisional application No. 61/039,227, filed on Mar. 25, 2008.

(51) Int. Cl. A01N 43/50; A01P 1/00

(52) U.S. Cl. 514/389

(57) ABSTRACT

Methods are provided for reducing or eliminating bacteria such as Salmonella in eggs for human consumption through the use of at least one N,N-dihalo-5,5-dialkylhydantoin in which each of the alkyl groups independently comprises from 1 to about 6 carbon atoms.

### BACKGROUND

Bacteria, such as Salmonella, are frequent causes of foodborne illness in humans, especially from handling and consumption of poultry and eggs. While in the past, antibiotics may have been suitable for treating/curing such illnesses, the long-term usage of antibiotics in both the poultry and beef industries may have resulted in strains of bacteria that are resistant to antibiotics.

Eggs have been consumed by humans for centuries. Chicken eggs are the most commonly consumed egg products. However, in parts of the world, other types of eggs such as ostrich, duck, goose, quail, etc, eggs are consumed.

Frequently, cooking eggs at high enough temperature will kill any Salmonella present. However, handling of the eggs prior to cooking is still a concern.

Given that it is preferable to humans who handle and consume eggs to not get ill from bacteria such as Salmonella, there is a need for commercially suitable means for minimizing or eliminating bacterial infection of eggs.

### THE INVENTION

This invention meets the above-described needs by providing methods of reducing or eliminating bacteria, such as Salmonella, in eggs suitable for human consumption, the methods comprising contacting at least a portion of the egg with an aqueous microbiocidal solution comprising at least one N,N-dihalo-5,5-dialkylhydantoin in which each of the alkyl groups independently comprises from 1 to about 6 carbon atoms.

The present invention also provides methods of reducing or eliminating bacteria, such as Salmonella, from eggs suitable for human consumption, the methods comprising contacting, one or more times, at least a portion of the egg with a) a sodium hypochlorite solution and b) i) at least one N,N-dihalo-5,5-dialkylhydantoin in which each of the alkyl groups independently comprises from 1 to about 6 carbon atoms, or (ii) an aqueous microbiocidal solution comprising at least one N,N-dihalo-5,5-dialkylhydantoin in which each of the alkyl groups independently comprises from 1 to about 6 carbon atoms or (iii) both (i) and (ii), and a) and b) can be conducted in any order.

The use of N,N-dihalo-5,5-dialkylhydantoins in the control of Salmonella in the processing of chickens is well known. For example, see U.S. Pat. Nos. 6,908,636 and 6,919,364; U.S. patent application Ser. No. 10/313,243 (Publication number 2003-0077365), Ser. No. 10/313,245 (publication number 2003-0211210), Ser. No. 11/103,703 (publication number 2005-0182117), Ser. No. 11/180,054 (publication number 2005-0271779), Ser. No. 10/603,132 (publication number 2004-0265446), and Ser. No. 10/603,130 (publication number 2004-0265445); and PCT Application Numbers US04/14762 (publication number WO 2005/04614), US04/43732 (publication number WO 2006/71224), and US04/43381 (publication number WO 2006/71215). However, heretofore, it has never been proposed to use N,N-dihalo-5,5-dialkylhydantoins in the control of Salmonella in eggs suitable for human consumption. The inventors hereof have unexpectedly discovered that the use of N,N-dihalo-5,5-dialkylhydantoins and/or aqueous solutions containing the same, can be used to control, or substantially eliminate, Salmonella in eggs suitable for human consumption.

Non-limiting examples of consumable eggs suitable for treatment by the present invention include those laid by chicken, ostrich, duck, goose, and quail.

In the practice of the present invention one or more consumable eggs is/are contacted with an aqueous solution comprising at least one N,N-dihalo-5,5-dialkylhydantoin, thus, N,N-dihalo-5,5-dialkylhydantoins used can be water soluble. N,N-dihalo-5,5-dialkylhydantoins suitable for use are those in which the alkyl groups, independently, each comprise from 1 to about 6, or in the range of from 1 to 4, carbon atoms. The N,N-dihalo-5,5-dialkylhydantoins can be those in which both of the halogen atoms are selected from bromine, or the N,N-dihalo-5,5-dialkylhydantoins can be those in which one of the halogen atoms is chlorine and the other is bromine or chlorine. Suitable compounds of this type include, for example, such compounds as 1,3-dibromo-5,5-dimethylhydantoin 1,3-dichloro-5,5-dimethylhydantoin, 1,3-dichloro-5,5-diethylhydantoin, 1,3-dichloro-5,5-di-n-butylhydantoin, 1,3-dichloro-5-ethyl-5-methylhydantoin, N,N′-bromochloro-5,5-dimethylhydantoin, N,N′-bromochloro-5-ethyl-5-methylhydantoin, N,N′-bromochloro-5-propyl-5-methylhydantoin, N,N′-bromochloro-5-isopropyl-5-methylhydantoin, N,N′-bromochloro-5-butyl-5-methylhydantoin, N,N′-bromochloro-5-isobutyl-5-methylhydantoin, N,N′-bromochloro-5-sec-butyl-5-methylhydantoin, N,N′-bromochloro-5-tert-butyl-5-methylhydantoin, N,N′-bromochloro-5,5-diethylhydantoin, and mixtures of any two or more of the foregoing. N,N′-bromochloro-5,5-dimethylhydantoin is available commercially under trade designation BROMICIDE biocide, available from Chemtura Corporation. Another suitable bromochlorohydantoin mixture is composed predominantly of N,N′-bromochloro-5,5-dimethylhydantoin together with a minor proportion by weight of 1,3-dichloro-5-ethyl-5-methylhydantoin. A mixture of this latter type is available in the marketplace under the trade designation DANTOBROM biocide, available from the Lonza Corporation.

It should be noted that when a mixture of two or more of the foregoing N,N′-bromochloro-5,5-dialkylhydantoins is used in the practice of the present invention, the individual N,N-dihalo-5,5-dialkylhydantoins of the mixture can be in any suitable proportions relative to each other. It will also be understood that the designation N,N′ in reference to, for example, N,N′-bromochloro-5,5-dimethylhydantoin means that this compound can be (1) 1-bromo-3-chloro-5,5-dimethylhydantoin, or (2) 1-chloro-3-bromo-5,5-dimethylhydantoin, or (3) a mixture of 1-bromo-3-chloro-5,5-dimethylhydantoin and 1-chloro-3--bromo-5,5-dimethylhydantoin. Also, it is conceivable that some 1,3-dichloro-5,5-dimethylhydantoin and 1,3-dibromo-5,5-dimethylhydantoin could be present in admixture with (1), (2) or (3).

If the at least one, in some cases only one, N,N-dihalo-5,5-dialkylhydantoin used in the practice of the present invention is a dibromo N,N-dihalo-5,5-dialkylhydantoin, the N,N-dibromo-5,5-dialkylhydantoin is 1,3-dibromo-5,5-dialkylhydantoin in which one of the alkyl groups is a methyl group and the other alkyl group contains in the range of 1 to about 6, or in the range of from 1 to 4, carbon atoms. Thus, N,N-dibromo-5,5-dialkylhydantoins can comprise 1,3-dibromo-5,5-dimethylhydantoin, 1,3-dibromo-5-ethyl-5-methylhydantoin, 1,3-dibromo-5-n-propyl-5-methylhydantoin, 1,3-dibromo-5-isopropyl-5-methylhydantoin, 1,3-dibromo-5-n-butyl-5-methylhydantoin, 1,3-dibromo-5-isobutyl-5-methylhydantoin, 1,3-dibromo-5-sec-butyl-5-methylhydantoin, 1,3-dibromo-5-tert-butyl-5-methylhydantoin, and mixtures of any two or more of them. Of these N,N-dibromo-5,5-dialkylhydantoins, 1,3-dibromo-5-isobutyl-5-methylhydantoin, 1,3-dibromo-5-ethyl-5-methylhydantoin, and 1,3-dibromo-5-n-propyl-5-methylhydantoin are most cost effective. Of the mixtures of the foregoing N,N-dibromo-5,5-dialkylhydantoins that can be used pursuant to this invention, 1,3-dibromo-5,5-dimethylhydantoin can be used as one of the components, e.g., as a mixture of 1,3-dibromo-5,5-dimethylhydantoin and 1,3-dibromo-5-ethyl-5-methylhydantoin. In this invention, at least one of the N,N-dihalo-5,5-dialkylhydantoins can be a mixture of at least 1,3-dibromo-5,5-dimethylhydantoin in combination with least one other N,N-dihalo-5,5-dialkylhydantoin, e.g., 1,3-dibromo-5-ethyl-5-methylhydantoin.

The at least one, in some cases only one, N,N-dihalo-5,5-dialkylhydantoin used herein can be water-soluble 1,3-dibromo-5,5-dialkylhydantoins in which one of the alkyl groups is a methyl group and the other is an alkyl group containing from 1 to about 6, or in the range of from 1 to 4, carbon atoms, e.g., 1,3-dibromo-5,5-dimethylhydantoin. This compound is available in the marketplace in tablet or granular form under the trade designations ALBROM 100T biocide and ALBROM 100PC biocide, both available commercially from the Albemarle Corporation.

It should be noted that when a mixture of two or more of the foregoing 1,3-dibromo-5,5-dialkylhydantoins is used in the practice of the present invention, the individual N,N-dibromo-5,5-dialkylhydantoins of the mixture can be in any suitable proportions relative to each other.

In the practice of the present invention the at least one, sometimes only one, N,N-dihalo-5,5-dialkylhydantoin above are solubilized in an aqueous medium to form aqueous microbiocidal solution. The aqueous medium can be water, e.g., potable water, or a suitable innocuous, water-soluble organic solvent, such as acetonitrile, with or without water. If water-soluble organic solvents are used, the eggs suitable for human consumption can be washed with clean (potable) water, after being contacted with the aqueous microbiocidal solution, to remove residues from such solvent.

The aqueous microbiocidal solution used in the practice of the present invention can be formed by combining, mixing, etc., the components of the aqueous microbiocidal solution in any order and by any method known, and the order in which they are combined is not critical to the instant invention and any method that can achieve substantially complete solubilization of the at least one N,N-dihalo-5,5-dialkylhydantoin in the aqueous medium can be used. For example, the aqueous microbiocidal solutions used pursuant to the present invention can be formed in many cases by adding the at least one N,N-dihalo-5,5-dialkylhydantoin itself (i.e., in undiluted form) to water. A concentrated solution containing the at least one N,N-dihalo-5,5-dialkylhydantoin and water can be formed, and then, when the aqueous microbiocidal solution is needed, additional water added to the concentrated solution to form an aqueous microbiocidal solution. If a water-soluble organic solvent is used in the preparation of the aqueous microbiocidal solutions, the at least one N,N-dihalo-5,5-dialkylhydantoin can be solubilized directly into the organic solvent. If a combination of organic solvent and water is used, the at least one N,N-dihalo-5,5-dialkylhydantoin can be solubilized in the water and then the organic solvent introduced, the at least one N,N-dihalo-5,5-dialkylhydantoin first solubilized in the organic solvent and then the water introduced, the at least one N,N-dihalo-5,5-dialkylhydantoin solubilized in a preformed mixture of the organic solvent, etc.

The concentration of the at least one N,N-dihalo-5,5-dialkylhydantoin in the aqueous microbiocide solution will vary depending on various factors such as the particular N,N-dihalo-5,5-dialkylhydantoin(s) being used, the nature and frequency of prior microbiocidal treatments, the types and nature of the bacteria (Salmonella) present, the amount and types of nutrients available to the bacteria (Salmonella), the nature and extent of cleansing actions, if any, taken in conjunction with the microbiocidal treatment, the surface or locus of the bacteria (Salmonella) being treated, and so on. In any event, a microbiocidally-effective amount of the aqueous microbiocide solution will be applied to or contacted with the egg(s).

Typically the aqueous microbiocide solution will contain a microbiocidally-effective amount of the at least one, sometimes only one, N,N-dihalo-5,5-dialkylhydantoin, which means that the aqueous microbiocide solution will typically have an active halogen concentration in the range of about 2 to about 1000 ppm (wt/wt), or in the range of about 2 to about 500 ppm (wt/wt), or in the range of about 25 to about 250 ppm (wt/wt), active halogen being determinable by use of the conventional DPD test procedure, which is described in U.S. Pat. No. 6,908,636. If the actual active halogen in the solution consists of active chlorine, the concentration of the diluted solution used can be at least two to three times higher than the minimums of the foregoing ranges. In the case of the 1,3-dibromo-5,5-dialkylhydantoins used pursuant to this invention, a particularly useful range for use in ordinary situations is in the range of about 50 to about 150 ppm (wt/wt) of active bromine. When contacting egg(s) with aqueous solutions formed from at least one 1,3-dibromo-5,5-dialkylhydantoin, it is useful to use a solution containing a microbiocidally effective amount of active bromine that does not significantly or appreciably bleach the “skin” of the egg(s). Such amount is typically within the range of about 0.5 to about 30 ppm (wt/wt) or in the range of about 5 to about 25 ppm (wt/wt) of active bromine as determinable by the DPD test procedure. It will be understood that departures from the foregoing ranges can be made whenever deemed necessary or desirable, and such departures are within the spirit and scope of the present invention. Consequently, depending upon the particular application of the aqueous microbiocide solution, the concentration of N,N-dihalo-5,5-dialkylhydantoin in the aqueous microbiocide solution can extend from as little as about 2 ppm N,N-dihalo-5,5-dialkylhydantoin up to as high as the maximum water solubility of the particular N,N-dihalo-5,5-dialkylhydantoin being used, at the temperature at which such aqueous microbiocide solution is being used.

It should be noted that although the above halogen concentrations are being measured according to the DPD method, there are two different types of procedures that can be used for determining active halogen content, whether active chlorine, active bromine or both. For measuring concentrations in the vicinity of above about 500 ppm or so (wt/wt) of active bromine or above about 1100 ppm of active chlorine, starch-iodine titration is a useful procedure, which method is described in U.S. Pat. No. 6,908,636. On the other hand, where concentrations are below levels in these vicinities, the conventional DPD test procedure is more suitable, as this test is designed for measuring very low active halogen concentrations, e.g., active chlorine concentrations in the range of from zero to about 11-12 ppm (wt/wt) or active bromine concentrations in the range of from zero to about 5 ppm (wt/wt). In fact, where the actual concentration of active chlorine is between about 11-12 ppm and about 1100 ppm (wt/wt), or the where the actual concentration of active bromine is between about 5 ppm and about 100 ppm (wt/wt), the test sample is typically diluted with potable water to reduce the actual concentration to be in the range of about 4 to about 11-12 ppm in the case of active chlorine and to be in the range of about 2 to about 5 ppm in the case of active bromine before making the DPD analysis. It can be seen therefore that while there is no critical hard-and-fast concentration dividing line between which procedure to use, the approximate values given above represent a practical approximate dividing line, since the amounts of water dilution of more concentrated solutions when using the DPD test procedure increase with increasing initial active halogen concentration, and such large dilutions can readily be avoided by use of starch-iodine titration when analyzing the more concentrated solutions. In short, with suitably dilute solutions use of the DPD test procedure is recommended, and with more concentrated solutions use of starch-iodine titration is recommended.

The egg(s) can be contacted with the aqueous microbiocide solution by any means known in the art. Non-limiting examples of suitable means include wiping the egg(s) with a towel that the aqueous microbiocide solution has been applied to, dipping the egg(s) in the aqueous microbiocide solution, spraying the aqueous microbiocide solution onto the egg(s), etc. The egg(s) can be submerged in the aqueous microbiocide solution.

The egg(s) can be first contacted one or more times with a sodium hypochlorite solution prior to contacting with the aqueous microbiocide solution. The concentration of the sodium hypochlorite in the solution is readily selected by one having ordinary skill in the art because sodium hypochlorite solutions such as these are commonly used in treating Salmonella in egg(s).

The present invention relates to a method of administering to one or more eggs (i) at least one N,N-dihalo-5,5-dialkylhydantoin in which each of the alkyl groups is independently selected from alkyl groups containing in the range of from 1 to about 6, or in the range of from 1 to 4, carbon atoms, or (ii) an aqueous microbiocidal solution containing at least one N,N-dihalo-5,5-dialkylhydantoin in which each of the alkyl groups is independently selected from alkyl groups containing in the range of from 1 to about 6, or in the range of from 1 to 4, carbon atoms, or (iii) both (i) and (ii). The treatment of egg(s) with (i), (ii), or (iii) is to substantially control, inhibit or eliminate Salmonella colonization or infestation in the treated egg(s) in comparison to the untreated egg(s). The egg(s) can be treated/contacted with an aqueous microbiocidal solution.

Typical amounts of aqueous microbiocidal solution effective to control, inhibit, reduce and/or eliminate. Salmonella may vary, for example, based on the type of egg(s), the weight of the egg(s), etc.

Methods of this invention have several advantages. For example, 1,3-dibromo-5,5-dimethylhydantoin (DBDMH) is a dry compound that is self-activated when added to water. Both bromines are released to form hypobromous acid and dimethyhydantoin (inert). Bromine is a better biocide than chlorine at higher pH (e.g., 7.5 and above). The biocide dosage is 0.5 to 2.0 ppm free bromine. Bromine has lower volatility then that of chlorine, so there is less evaporation loss. Bromine-based biocides are more effective in water containing ammonia contaminants (like proteins).

It is to be understood that this invention is not limited to any one specific embodiment exemplified herein. It is also to be understood that the reactants and components referred to by chemical name or formula anywhere in the specification or claims hereof, whether referred to in the singular or plural, are identified as they exist prior to being combined with or coming into contact with another substance referred to by chemical name or chemical type (e.g., another reactant, a solvent, or etc.). It matters not what chemical changes, transformations and/or reactions, if any, take place in the resulting combination or solution or reaction medium as such changes, transformations and/or reactions are the natural result of bringing the specified reactants and/or components together under the conditions called for pursuant to this disclosure. Thus the reactants and components are identified as ingredients to be brought together in connection with performing a desired chemical reaction or in forming a combination to be used in conducting a desired reaction. Accordingly, even though the claims hereinafter may refer to substances, components and/or ingredients in the present tense (“comprises”, “is”, etc.), the reference is to the substance, component or ingredient as it existed at the time just before it was first contacted, combined, blended or mixed with one or more other substances components and/or ingredients in accordance with the present disclosure. Whatever transformations, if any, which occur in situ as a reaction is conducted is what the claim is intended to cover. Thus the fact that a substance, component or ingredient may have lost its original identity through a chemical reaction or transformation during the course of contacting, combining, blending or mixing operations, if conducted in accordance with this disclosure and with the application of common sense and the ordinary skill of a chemist, is thus wholly immaterial for an accurate understanding and appreciation of the true meaning and substance of this disclosure and the claims thereof. As will be familiar to those skilled in the art, the terms “combined”, “combining”, and the like as used herein mean that the components that are “combined” or that one is “combining” are put into a container with each other. Likewise a “combination” of components means the components having been put together in a container.

White the present invention has been described in terms of one or more preferred embodiments, it is to be understood that other modifications may be made without departing from the scope of the invention, which is set forth in the claims below.

What is claimed is:

1. A method of reducing or eliminating bacteria in one or more eggs suitable for human consumption comprising contacting the one or more eggs with an aqueous microbiocidal solution comprising at least one N,N-dihalo-5,5-dialkylhydantoin in which each of the alkyl groups independently comprises from 1 to about 6 carbon atoms.

2. The method according to claim 1 wherein the microbiocidal solution has an active halogen concentration in the range of from about 2 to about 1000 ppm (wt/wt) active halogen.

3. The method according to claim 1 wherein the one or more eggs comprise chicken, ostrich, duck, goose, or quail egg.

4. The method according to claim 1 wherein the at least one N,N-dihalo-5,5-dialkylhydantoin is water soluble.

5. The method according to claim 1 wherein the at least one N,N-dihalo-5,5-dialkylhydantoin is selected from those in which one of the halogen atoms is chlorine and the other is bromine or chlorine.

6. The method according to claim 1 wherein the alkyl groups of the at least one N,N-dihalo-5,5-dialkylhydantoin each independently comprise from 1 to about 4 carbon atoms.

7. The method according to claim 1 wherein the at least one N,N-dihalo-5,5-dialkylhydantoin is selected from 1,3-dichloro-5,5-dimethylhydantoin, 1,3-dichloro-5,5-diethylhydantoin, 1,3-dichloro-5,5-di-n-butylhydantoin, 1,3-dichloro-5-ethyl-5-methylhydantoin, N,N′-bromochloro-5,5-dimethylhydantoin, N,N′-bromochloro-5-ethyl-5-methylhydantoin, N,N′-bromochloro-5-propyl-5-methylhydantoin, N,N′-bromochloro-5-isopropyl-5-methylhydantoin, N,N′-bromochloro-5-butyl-5methylhydantoin, N,N′-bromochloro-5-isobutyl-5-methylhydantoin, N,N′-bromochloro--5-sec-butyl-5-methylhydantoin, N,N′-bromochloro-5-tert-butyl-5-methylhydantoin, N,N′-bromochloro-5,5-diethylhydantoin, 1,3-dibromo-5,5-dialkylhydantoin in which one of the alkyl groups comprises a methyl group and the other alkyl group comprises from 1 to about 6 carbon atoms, and mixtures of any two or more of the foregoing.

8. The method according to claim 4 wherein the at least one N,N-dihalo-5,5-dialkylhydantoin is 1,3-dibromo-5,5-dialkylhydantoin in which one of the alkyl groups is a methyl group and the other alkyl group comprises from 1 to about 6 carbon atoms.

9. The method according to claim 8 wherein the at least one N,N-dihalo-5,5-dialkylhydantoin is selected from 1,3-dibromo-5,5-dimethylhydantoin, 1,3-dibromo-5-ethyl-5-methylhydantoin, 1,3-dibromo-5-n-propyl-5-methylhydantoin, 1,3-dibromo-5-isopropyl-5-methylhydantoin, 1,3-dibromo-5-n-butyl-5-methylhydantoin, 1,3-dibromo-5-isobutyl-5-methylhydantoin, 1,3-dibromo-5-sec-butyl-5-methylhydantoin, 1,3-dibromo-5-tert-butyl-5-methylhydantoin, and mixtures of any two or more of them.

10. The method according to claim 1 wherein the microbiocidal solution has an active halogen concentration in the range of from about 25 to about 250 ppm (wt/wt) active halogen.

11. A method of reducing or eliminating bacteria in one or more eggs suitable for human consumption comprising contacting, one or more times, the one or more eggs with a) a sodium hypochlorite solution and b) i) at least one N,N-dihalo-5,5-dialkylhydantoin in which each of the alkyl groups independently comprises alkyl group containing from 1 to about 6 carbon atoms, or (ii) an aqueous microbiocidal solution containing at least one N,N-dihalo-5,5-dialkylhydantoin in which each of the alkyl groups independently comprises alkyl group containing from 1 to about 6 carbon atoms, or (iii) both (i) and (ii), and a) and b) can be conducted in any order.

12. The method according to claim 11 wherein the microbiocidal solution has an active halogen concentration in the range of from about 2 to about 1000 ppm (wt/wt) active halogen, as determined by the DPD test procedure.

13. The method according to claim 11 wherein the one or more eggs comprise chicken ostrich, duck, goose, or quail egg.

14. The method according to claim 11 wherein the at least one N,N-dihalo-5,5-dialkylhydantoin is selected from those in which one of the halogen atoms is chlorine and the other is bromine or chlorine, or those in which both halogen atoms are bromine.

15. The method according to claim 11 wherein the alkyl groups of the at least one N,N-dihalo-5,5-dialkylhydantoin, are each independently alkyl group containing in the range of from 1 to 4 carbon atoms.

16. The method according to claim 11 wherein the at least one N,N-dihalo-5,5-dialkylhydantoin is 1,3-dibromo-5,5-dialkylhydantoin in which one of the alkyl groups is a methyl group and the other alkyl group contains in the range of from 1 to 6 carbon atoms.

17. The method according to claim 16 wherein the at least one N,N-dihalo-5,5-dialkylhydantoins is a mixture of at least 1,3-dibromo-5,5-dimethylhydantoin in combination with at least one other N,N-dihalo-5,5-dialkylhydantoin.

18. The method according to claim 16 wherein the at least one N,N-dihalo-5,5-dialkylhydantoin is a mixture of 1,3-dibromo-5,5-dimethylhydantoin and 1,3-dibromo-5-ethyl-5-methylhydantoin.

19. The method according to claim 14 wherein the at least one N,N-dihalo-5,5-dialkylhydantoin is 1,3-dibromo-5,5-dimethylhydantoin.

20. The method according to claim 11 wherein the microbiocidal solution has an active halogen concentration in the range of from about 25 to about 250 ppm (wt/wt) active halogen.

21. The method according to claim 14 wherein the microbicidal solution is formed by solubilizing in an aqueous medium said at least one N,N-dihalo-5,5-dialkylhydantoin.

22. The method according to claim 21 wherein the aqueous medium is water, a water-soluble organic solvent, or mixtures thereof.

23. The method according to claim 22 wherein the aqueous medium is selected from water-soluble organic solvents and mixtures of water and water-soluble organic solvent.

24. The method according to claim 23 wherein the one or more eggs are washed with potable water, after being contacted with the microbicidal solution.
